(19) United States
(12) Patent Application Publication
(10) Pub. No.: US 2003/0172003 A1
(43) Pub. Date: Sep. 11, 2003

(54) Method and system for designing configurable furniture product

(76) Inventors: Richard M. Holbrook, Altadena, CA (US); Michael L. Shannon, La Canada, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/091,806

(22) Filed: Mar. 6, 2002

(51) Int. Cl. G06F 17/60

(52) U.S. Cl. 705/27

(57) ABSTRACT

In one embodiment, the present invention relates to a web-based computer software tool for designing and configuring furniture such as, desks, shelves, work stations from a unified system of modular furniture components. The tool includes a database of three dimensional (3-D) modular furniture components graphically selectable by a user. The modular components are selected and “dragged-and-dropped” in a 3-D grid display to enable the user to design a finished configurable furniture product from the selected components. The database includes item information such as description, price, technical spec., etc., for each component.

### FIELD OF THE INVENTION

The present invention involves designing a system of modular furniture components and sub-assemblies optimized for mass-customization by individual end-users through computer software and distributed computer networks such as the Internet. More particularly, the present invention is directed to a furniture builder software that utilizes a group of modular components specifically designed to be configured via the builder software to provide mass individual customization of high-quality, BIFMA-approved furniture without incurring the manufacturing costs traditionally associated with individually designed custom furniture and simultaneously eliminating costs from the traditional furniture sales and distribution channel by using computer software and distributed networks such as the Internet to streamline the sales, order-entry, and fulfillment processes.

### BACKGROUND OF THE INVENTION

The existing successful purveyors of high-quality, BIFMA-approved, office furniture have evolved a business model, including manufacturing, sales, product specification and order-entry, and distribution and fulfillment based on the fact that most office workers were employed by large organizations and office furniture purchases were made by the employers in very large order sizes. After decades of mergers and downsizings, however, the fact is that presently, and increasingly so in the future, the majority of office workers are employed in small businesses. In addition, the steadily growing trend for office workers to use home offices or tele-commuting offices reinforces this trend such that the traditional office furniture business model of the occasional large sale to equip a corporate office housing hundreds or thousands of workers, essentially manufactured to order such that 12-16 week lead times were acceptable, is increasingly un-suited to the needs of the majority of office workers.

To adapt to the needs of the majority of the users of office furniture the purveyors of these products must develop the means and systems to serve the largest and most rapidly growing part of the market for office furniture. These consumers of office furniture products, who have probably acquired their office furniture in the past from mass-marketers of low quality, mass-produced furniture such as IKEA™, often have no knowledge of the availability of superior furniture. Even if they have investigated acquiring high-quality, BIFMA-approved furniture the traditional office furniture business model responds to a potential small order with substantially higher “list” prices and unacceptably long sales, order-entry and fulfillment cycles (12-16 weeks) completely unacceptable to these customers.

Therefore there is a need for a cost-effective, high-quality, BIFMA-approved furniture design combined with a streamlined, fast, efficient, easy-to-use mass-customization configuration, order entry and fulfillment system accessible directly by the furniture end user.

### SUMMARY OF THE INVENTION

In one embodiment, the present invention relates to a unified system of modular furniture components and web-based computer software tool for designing and configuring furniture such as, desks, shelves, work stations from that group of modular furniture components. The modular furniture components are designed with the software tool in mind and the tool is designed with the unified system in mind. The tool includes a database of three dimensional (3-D) modular furniture components graphically selectable by a user. The modular components are selected and “dragged-and-dropped” in a 3-D grid display to enable the user to design a finished configurable furniture product from the selected components. The database includes item information such as description, price, technical specification, etc., for each component. Once the design is completed by the user, the tool provides a report including total cost, parts list, footprint, order form, etc., to the user so that the user can electronically place his/her order for the components of the designed product.

In one aspect, the invention relates to a method for designing a configurable furniture product comprising the steps of: accessing a plurality of 3-D modular furniture components stored in a database via a computer network; displaying a portion of the stored plurality of 3-D modular furniture components selectable by a user; placing one or more of the displayed modular furniture components in a displayed screen responsive to a set of predetermined placement rules; and arranging the placed modular furniture components to design the configurable furniture product.

In another aspect, the invention is directed to a method for designing a configurable furniture product utilizing a system of modular furniture components, the method comprising the steps of: storing a plurality of 3-D modular furniture components in a database accessible via a computer network; storing a plurality of requirements input by an administrator; displaying a portion of the plurality of 3-D modular furniture components selectable by a user; accepting inputs from the user for placing one or more of the displayed modular furniture components in a displayed screen; and configuring the placed modular furniture components to design the configurable furniture product responsive to the stored requirements.

### BRIEF DESCRIPTION OF THE DRAWINGS

The objects, advantages and features of this invention will become more apparent from a consideration of the following detailed description and the drawings, in which:

FIG. 1 is an exemplary system, according to an embodiment of the present invention;

FIG. 2 is an exemplary process flow, according to an embodiment of the present invention;

FIG. 3 is an exemplary screen for selected desks in a catalog;

FIG. 4 is an exemplary screen for one selected desk in a catalog;

FIG. 5 is an exemplary screen of search results for a search for “desk;”

FIG. 6 is an exemplary display of saved items;

FIG. 7 is an exemplary process flow for a furniture builder, according to an embodiment of the present invention;

FIGS. 8A and 8B are exemplary screens of the builder tool, according to an embodiment of the present invention;

FIG. 9A is an exemplary screen of a virtual shopping cart;

FIG. 9B is an exemplary screen for check out;

FIG. 10 is an exemplary process flow for managed customization, according to an embodiment of the present invention;

FIGS. 11A-11E are exemplary screens for a managed customization process, according to an embodiment of the present invention;

FIG. 12 is an exemplary arrangement of a furniture system, according to an embodiment of the present invention; and

FIGS. 13-15 are exemplary modular components, according to an embodiment of the present invention.

### DETAILED DESCRIPTION

In one embodiment, the system of the present invention utilizes a unified system of furniture subassembly components that can be combined in a variety of ways to easily assemble different configurations of furniture such as, office furniture or home furniture to satisfy the unique needs and desires of many individual end users. This variety of ways of configuring the modular components to design different combinations of furniture does not require additional design, specification, and manufacturing changes or activity because the furniture subassembly components have been designed in order to be configured by the user. Furthermore, an online furniture configurator is designed complementary to the particular unified system of furniture subassembly components and the goal of mass customization.

For example, common cabinet assemblies having vertically extending side support surfaces with multiple perforations or slots along the interior of the side surfaces allow for placement of fixtures such as shelving or drawers, but are limited in arrangement because of the fixed locations of the side surfaces and the slots. In addition, the configuration of the ultimate installation cannot be configured or modeled in advance, other than by laborious hand-drawn sketches or drawings. However, the present invention utilizes a modular, pre-fabricated group of components to design and configure a variety of furniture arrangements customized by the end user. This modular and flexible furniture component system is described in a co-pending and commonly assigned U.S. Patent Application being file simultaneously with this application (Attorney Docket Number 45789/GSL/0205), the contents of which are herein expressly incorporated by reference.

In one embodiment, the system and method of the present invention are capable of providing ergonomic tips and feedback as the user is placing the selected parts in the 3-D grid. Additionally, the system may be integrated with space analyzer and space planning tools to provide space design tips and feedback. Once the configuration design is completed by the user, the system provides a report including total cost, parts list, dimensions, order form, etc., to the user so that the user can electronically place his/her order. In one embodiment, the system and method include the capability of an intermediary, for example, an employer of the end-user, to pre-determine the extent of permitted customization by designated users. Furthermore, in this embodiment, the system includes various features to facilitate sales and order entry by typical existing contract furniture sales-force.

In using an embodiment of the invention for designing a configurable furniture arrangement, the user may start putting together the modular furniture components from scratch by drag-and-dropping the displayed components from one area to another area. Alternatively, the user has the option of browsing through a catalog and selecting a displayed configuration from the catalog as a starting point. The invention is a rule-based system and method that includes a plurality of rules for placing components on a displayed grid. The modular furniture components are designed with the goal of being used with the configurator system for numerous seamless variety of different configurations.

For the sake of specificity, but without loss of generality, the following description is couched in terms of an exemplary website for configuring furniture from subassembly components in order to make the descriptions more concrete, although the inventive subject matter itself applies to any interactive, computer network-based settings.

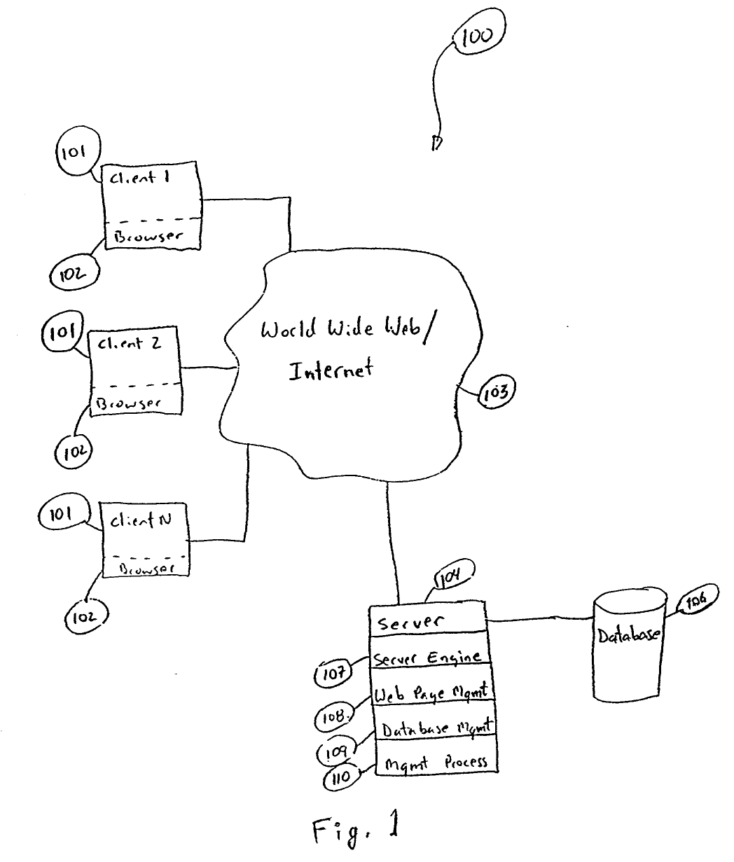

FIG. 1 and the following related discussion provide a brief, general description of a suitable computing environment in which an exemplary embodiment of the invention is implemented. Although not required, the embodiments of the invention are described in the general context of computer-executable instructions, for example, routines executed by a general-purposes computer, such as a personal computer. Those skilled in the relevant art will appreciate that the invention can be practiced with other computer system configurations, including Internet appliances, hand-held devices, cellular phones, multiprocessor systems, multiprocessor-based or programmable consumer electronics, network PCs, minicomputers, mainframe computers, and the like.

The invention can be embodied in a specific-purpose computer or data processor that is specifically programmed, configured or constructed to perform one or more of the computer-executable instructions explained in detail below. The invention can also be practiced in distributed computing environments where tasks or modules are performed by remote processing devices, which are linked through a communications network. In a distributed computing environment, program modules or subroutines may be located in both local and remote memory storage devices. In general, while hardware platforms, such as terminals and controllers, are described herein, aspects of the invention are equally applicable to nodes on the network having corresponding resource locators to identify such nodes.

Unless described otherwise, the construction and operation of the various blocks shown in FIG. 1 are of conventional design. As a result, such blocks need not be described in further detail herein, as they will be readily understood by those skilled in the relevant art.

Referring to FIG. 1, a system 100 in accordance with an embodiment of the invention includes one or more client computers 101, each of which includes a browser program module 102 that permits the computer to access and exchange data with a computer network, such as the Internet, including web sites within a World Wide Web (“Web”) portion 103 of the Internet. The client computers 101 may include one or more central processing units or other logic processing circuitry, memory, input devices (e.g., keyboards and pointing devices), output devices. (e.g., display devices and printers), and storage devices (e.g., fixed, floppy and optical disk drives, magnetic cassettes, flash memory cards, digital video disks (DVDs), RAMs, ROMs, smart cards, etc.), all well known but not shown in FIG. 1. The client computers 101 may also include other program modules, such as an operating system, one or more application programs (e.g., word processing or spread sheet applications), and the like. The client computers 101 can be operated by a user such as a customer or potential customer for configuring furniture from modular components.

A server computer 104, coupled to the Web 103, performs much or all of the organizing, accessing, and display processes. A database 106, coupled to the server computer 104, stores much of the data exchanged between the client computers 101, and the server computer 104, as described below.

The server computer 104 includes a server engine 107, a web page management component 108, a database management component 109, a management process component 110, as well as other components not shown in FIG. 1. As described more fully below, the server engine 107, the web page management component 108, the database management component 109, and the management process component 110 operate together to retrieve information from the database 106 and provide the information to the client computers 101 according to functions of the present invention. In one embodiment, the server computer 104 and the database 106 can form a single computing platform. Alternatively, the functions performed by the server computer 104 and/or the database 106 can be distributed over a plurality of platforms. In one embodiment, the functions and steps of the present invention are implemented on server 104 using JAVA programming language and Shock Wave™ 3-D software tools. These functions and steps are then made available to the client computers 101 via the Internet 103. Users can then utilize browsers 102 to use the functions and steps of this embodiment of the present invention.

In other embodiments, the system 100 can be incorporated in contexts other than the Internet, such as other distributed computing environments, or stand-alone computing environments. For example, the system 100 can be incorporated into a kiosk placed in a shopping mall, a furniture dealership or retail store, or other locations.

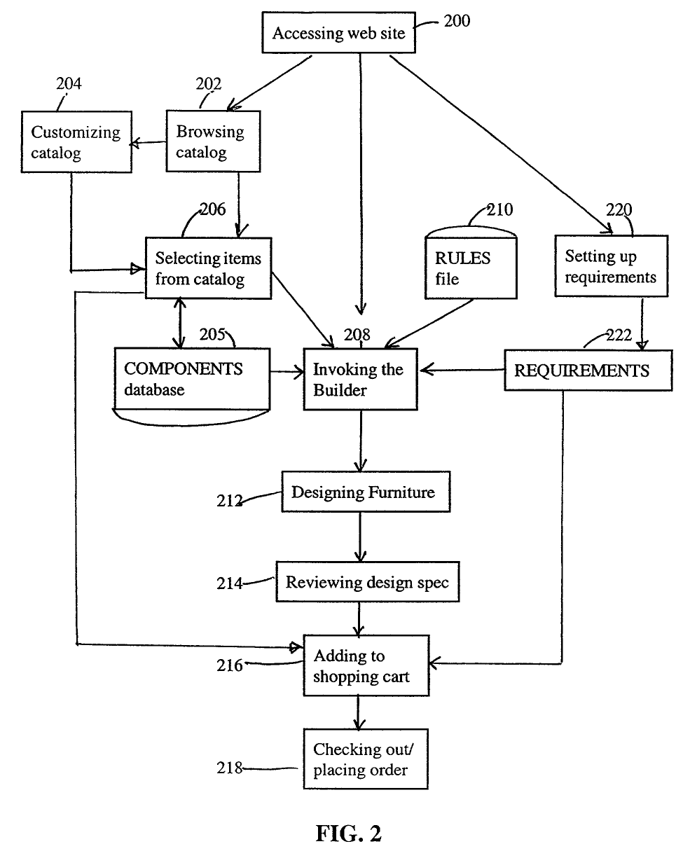

FIG. 2 is an exemplary process flow for designing furniture products, according to one embodiment of the present invention. In block 200, a website running on a server such as the server computer 104 of FIG. 1, is accessed by a user. Upon entering the website, the user has the option of browsing through a catalog of furniture products (block 202) and selecting a desired product (block 206) for modification and customization using a furniture builder system and method. In one embodiment, the user can build and save a customize catalog of different configurations that the user frequently uses, as depicted in block 204. The user may electronically transmit (e.g., email) his custom catalog to other people or electronically share the custom catalog with other people.

Alternatively, the user can invoke the furniture builder (block 208) to customize and configure a desirable product utilizing the modular components as the building blocks, as shown in block 208. The furniture builder is responsive to a set of rules 210 including relationships between the modular components used for placement of the modular components. The rule set 210 also includes industry standards, ergonometrics data, and other placement related data. In one embodiment, the rule set is easily replaceable to accommodate new rules for instance, for different types of users or different countries. For example, the system knows (without any effort from the user) that two shelves cannot be placed closer than a predetermined spacing distance from each other and thus does not allow the user to place components in violation of the rule set. Furthermore, if the user attempts to place a work surface (a shelf) in a grid area that does not have a rail, the system automatically extends an existing displayed rail to allow the attempted placement of the work surface.

The system includes a database 205 of 3-D modular furniture components graphically displayed and selectable by the user. The modular components are selected from a pallet and “dragged-and-dropped” in a 3-D grid display to enable the user to design a customized configurable furniture product. Once within the builder, the user can select modular components from a displayed list, place then in a virtual 3-D grid-like screen, edit any components, assign options, and add accessories to design a highly customized furniture product, as depicted in block 212. In block 214, a specification for the completed design generated by the system may be reviewed by the user. The specification includes a detailed description about the components used, the quantity of each component used, the associated cost of each component, physical dimensions of the designed product, and the like. When the user is satisfied with the designed product, the completed design is saved and added to a virtual shopping cart, as shown in block 216.

In block 218, an order for the design furniture product is electronically placed with the manufacturer or distributor. The components are then shipped to an address specified in the order form. In one embodiment, the components comprising the completed product may be packaged and shipped according to user preference specified in the order. This substantially enhances the fulfilment process by essentially providing “pick and pack” instructions to the fulfilment center that make fulfilling a large variety of custom orders as no more time-consuming or costly as fulfilling “standard” orders. Instructions for simple assembly of the components may be shipped or electronically transmitted to the user. Again, the design of the modular components system allows for ease of assembly by the buyer.

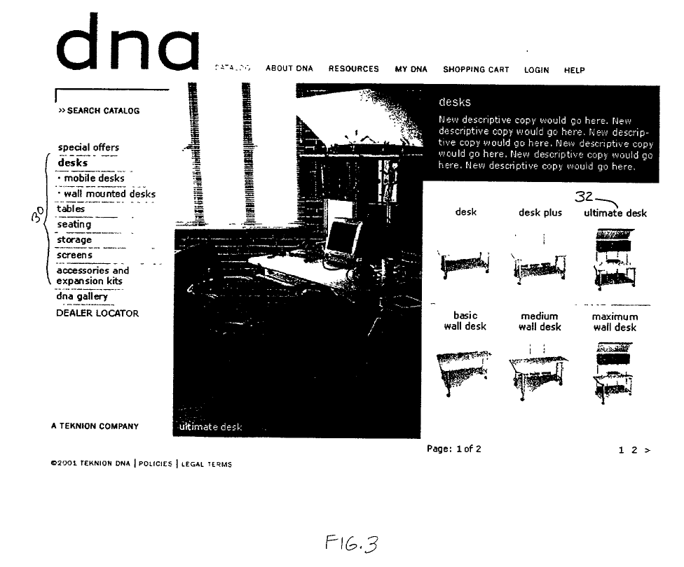

FIG. 3 is an exemplary screen for selected desks in a catalog. A typical catalog includes a list 30 of desks, tables, seating, storage, screens, and accessories. As shown in FIG. 3, clicking on desks item of the list, causes the system to display thumbnail images of different desks available in the catalog. Catalog navigation is expandable to display sub-categories, if any. In this example, “desks” category includes “mobile desks” and “wall mounted desks” sub-categories.

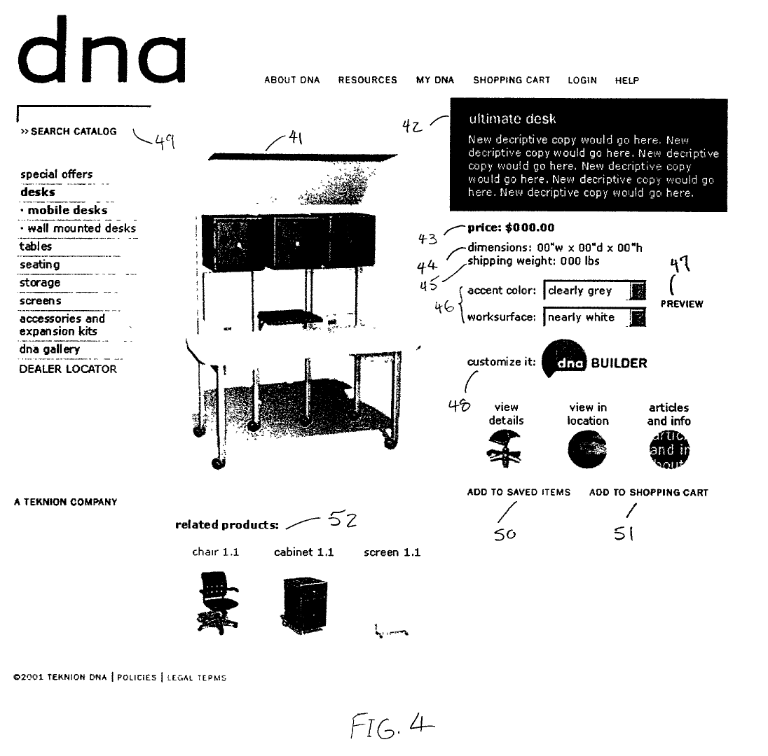

Selecting an item from the displayed images, causes the system to display a screen including more detailed information about the selected item. In this example, if the user selects “ultimate desks” 32 from the displayed images, the exemplary screen of FIG. 4 is displayed. This exemplary screen includes an image of the ultimate desks 41, a description of the selected item 42 (“ultimate desks”), dimensions 44, shipping weight 45, price 43, and some related products 52. The user can select and assign options 46 such as, accent color and work surface from this screen. The option selections can be previewed by clicking on the PREVIEW button 47. As a result, the system refreshes the image of the item with the new options. At this time, the user may use the builder program to customize the selected item by clicking on the “BUILDER” button 48.

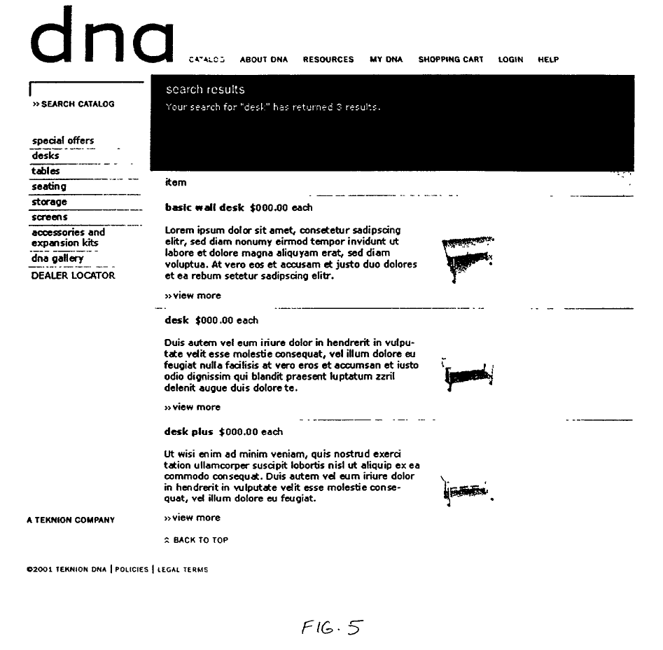

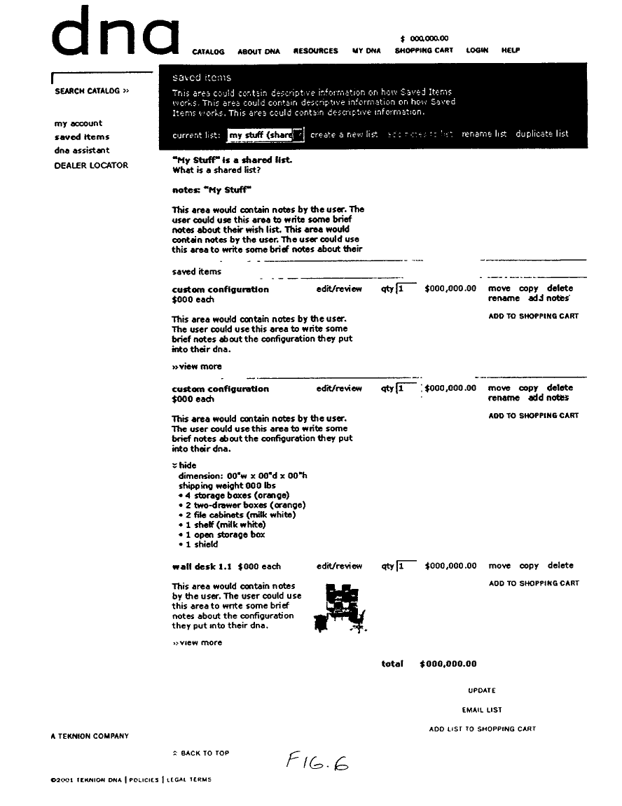

If desired, the user may add the displayed (customized) item to his shopping card or to his saved items by clicking on ADD TO SHOPPING CART 51, or ADD TO SAVED ITEMS 50 buttons, respectively. An exemplary display of saved items is illustrated in FIG. 6. Additionally, a search function 49 is available to the user for searching the entire catalog. FIG. 5 is an exemplary screen of search results for a search for “desk.” The search results include a description of the item, price, small image, and other related information.

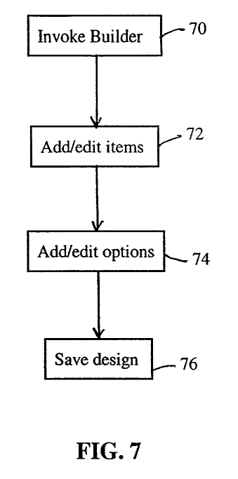

FIG. 7 is an exemplary process flow for a furniture builder, according to one embodiment of the present invention. In block 70, the builder is invoked by clicking on the “BUILDER” button 48 of FIG. 4, or from a page of the website as shown by block 208 of FIG. 2. If the user is not already logged in the system, a login window is displayed for the user to enter her relevant information and log into the system. In block 72, components are added to either a previously selected and saved catalog item, or an empty template for designing a customized furniture product. Options are added to the designed product in block 74 and the completed product is saved in block 76.

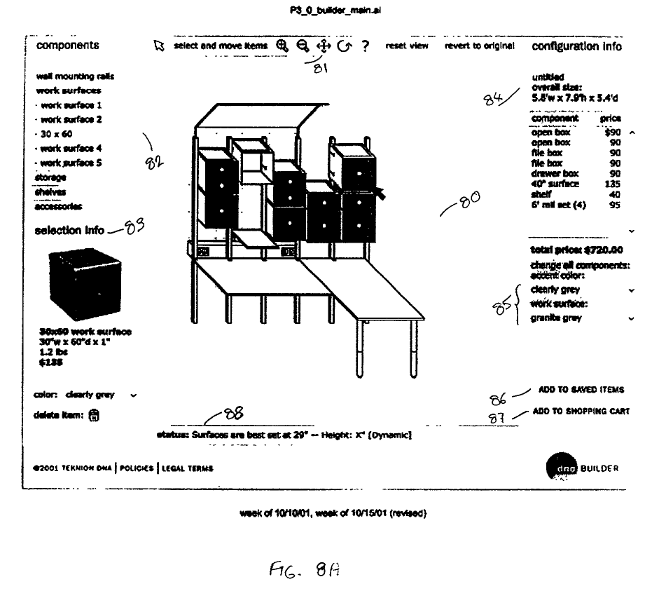

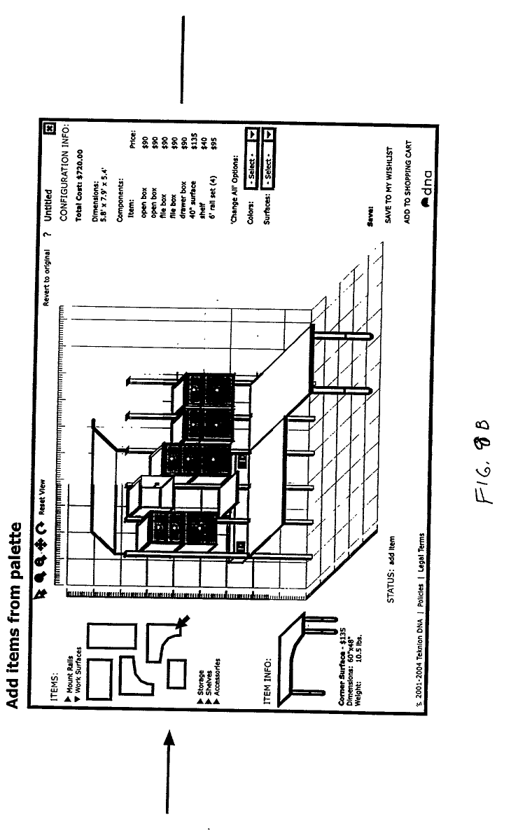

FIG. 8A is an exemplary screen of the builder tool, according to one embodiment of the present invention. As shown, a virtual 3-D background grid 80 is displayed for placing the modular components displayed on pallet 82. The displayed components can be simply dragged-and-dropped on a location on the grid 80. The builder tool applies a set of rules when the components are being placed on the grid so that the components comply with physical, ergonomics, environmental, and the like rules. The tool bar 81 includes a set of 3-D functions for navigating the 3-D space and moving items around this space. Detailed information about a selected component (from pallet 82) is displayed in area 83, while information about the configuration being designed is displayed in area 84. Status information, ergonomic tips, and space analysis data are displayed in the status area 88. Options are selected and assigned by buttons in area 85. The final design may be added to saved items or a shopping cart by clicking on buttons 86 and 87, respectively. Similar to FIG. 8A, FIG. 8B is an exemplary screen of the builder tool. In this screen, “work surfaces” from pallet 82 is selected to display different available work surfaces to be selected and placed on the grid 80.

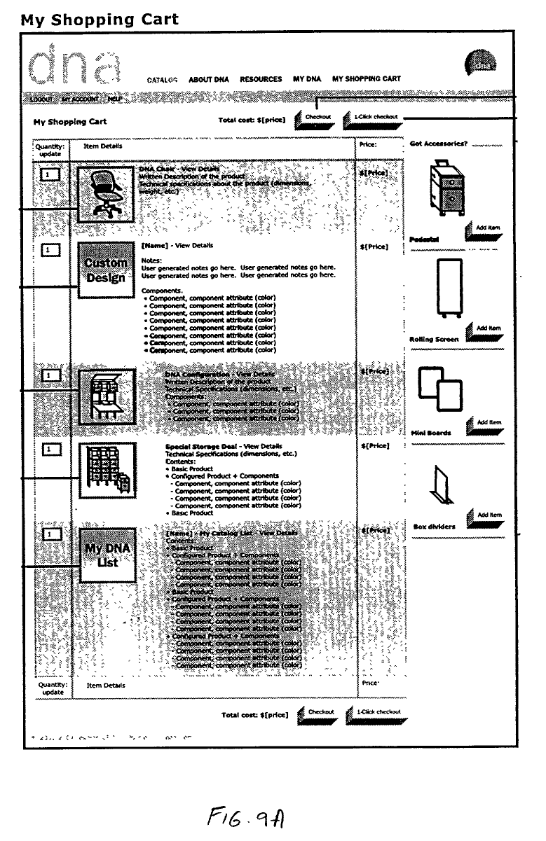

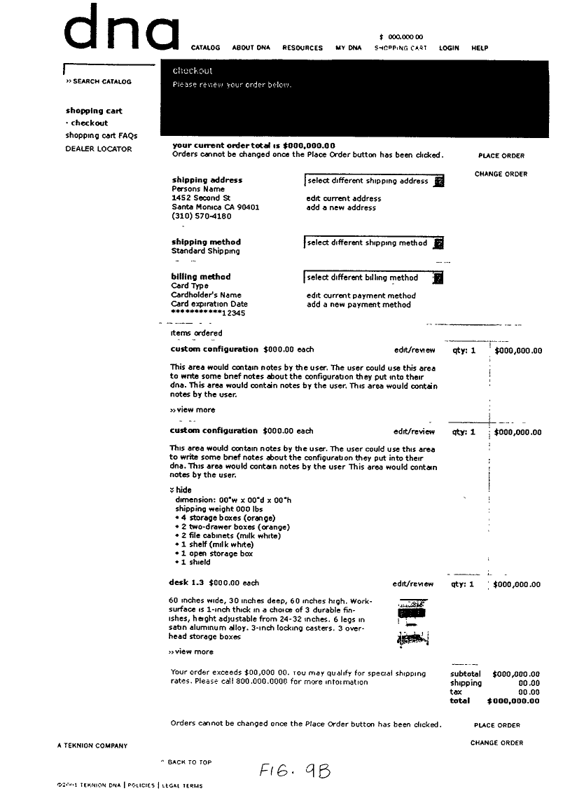

Referring back to FIG. 2, after completing the design, the user proceeds to check out and place her order in block 218. FIG. 9A is an exemplary screen of a virtual shopping cart. The quantity, detail description, and an image of each item in the design is displayed. The user may still add components to the design before he proceed to check the design out. FIG. 9B is an exemplary screen for check out. As shown, detail relevant information about the order such as total price, and description of each component including quantity and price are displayed. Shipping address, shipping method and billing address are specified by the user in this screen. At this time, the user has an option to make last-minute changes before an order is placed.

In one embodiment of the present invention, the system is capable of managed customization. This capability provides a ??? manager (e.g., a facility manager) with the ability to manage a group of people (employees) by limiting their customization options to certain requirements, such as budget, certain allowed colors, certain components, total number of components used, and the like. Within those requirements, each employee may design unique furniture configurations that would fit his specific purpose and taste.

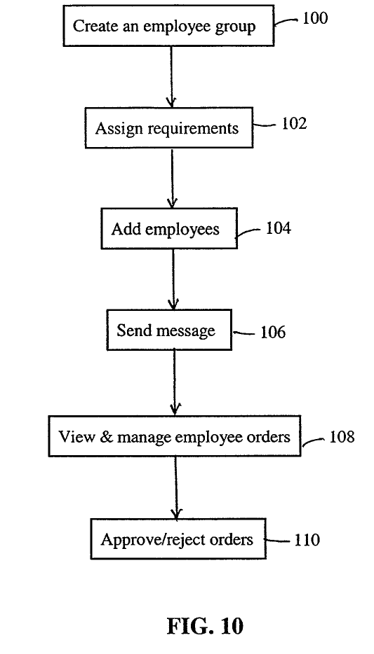

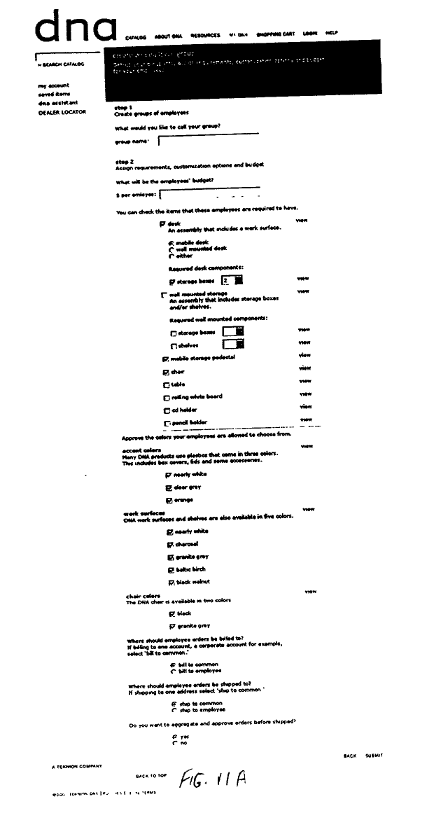

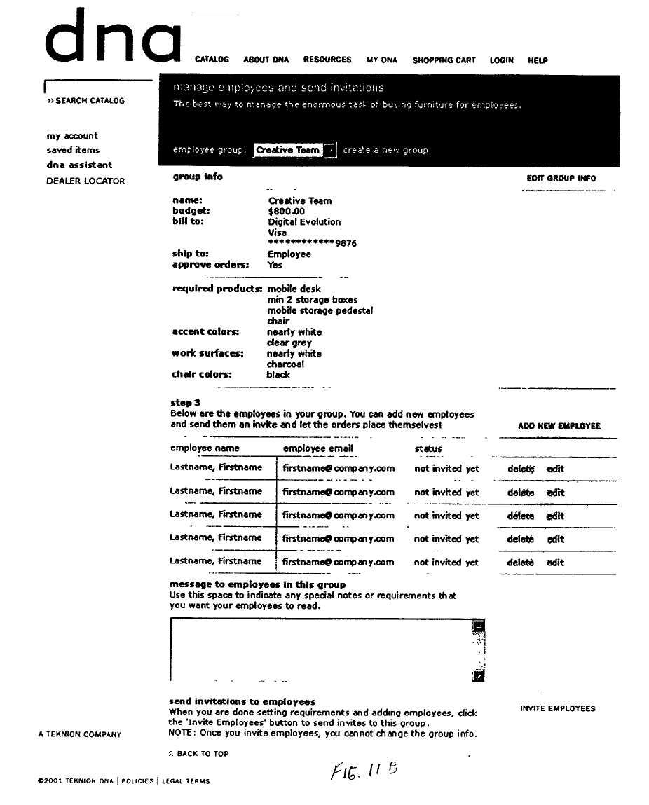

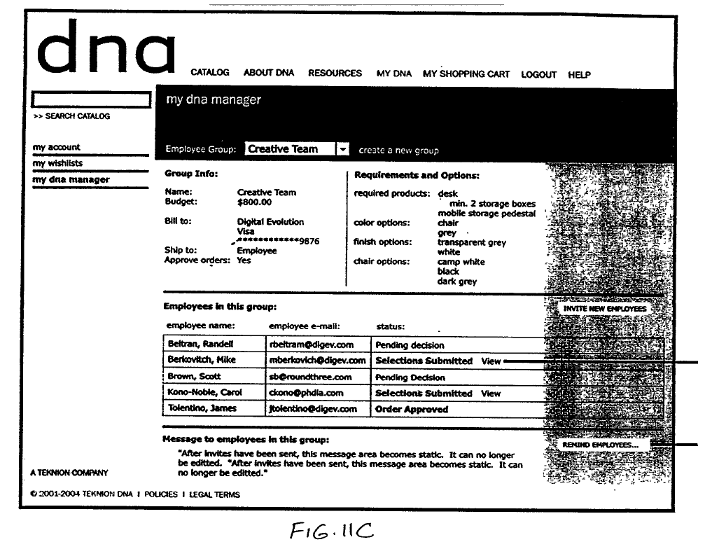

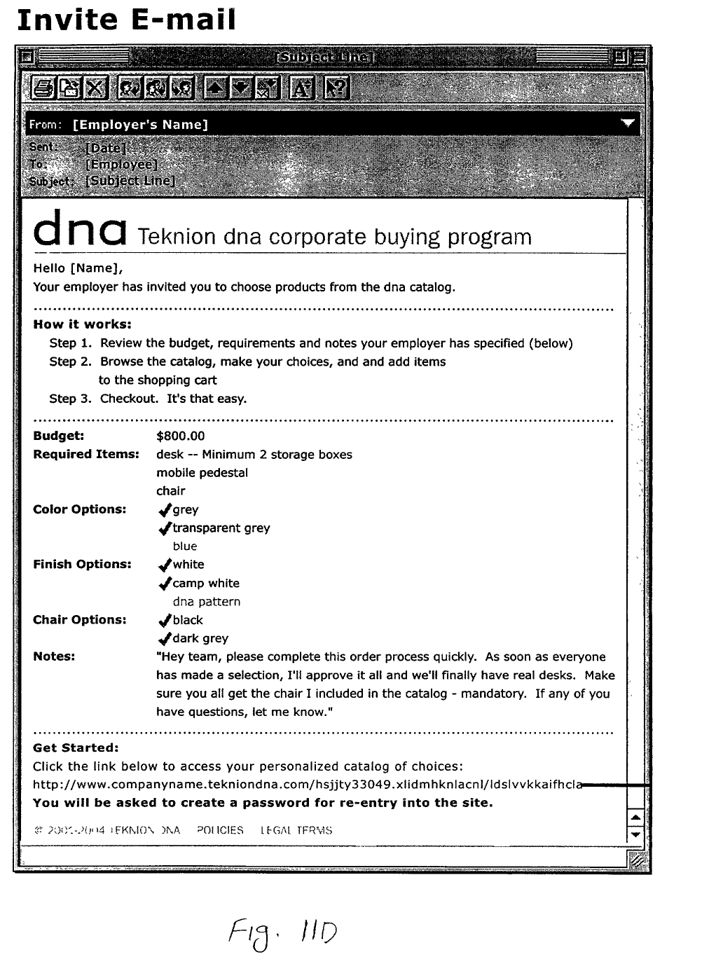

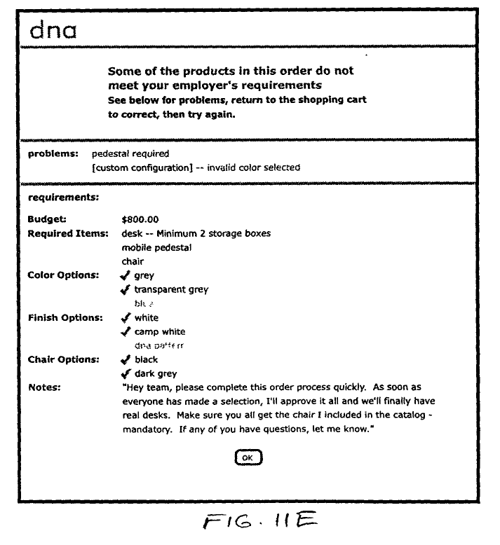

FIG. 10 is an exemplary process flow for managed customization. The facility manager or employer creates an employee group in block 100. The administrator then assigns requirements for the group. FIG. 11A is an exemplary screen for creating an employee group and assigning requirements to the group. A budget for each member of the group is specified and requirements such as component types, number of each type, color, and the like are then assigned to the group. As shown, a list of items that the group is required to have is displayed and the desired items are checked by the administrator. A list of items that the group is forbidden to have, may also be displayed to be selected and checked by the administrator.

Referring back to FIG. 10, the administrator then adds employees to the created group, as depicted in block 106. At this point, the administrator can send a message (invitation), such as an email to the employees in the group. FIGS. 11B and 11C are exemplary screens for reviewing the requirements, the employees, and sending a message to the employees. The employees can then start designing their customized furniture configurations within the requirements imposed by the administrator using the builder. FIG. 11D is an exemplary screen of the content of the email received by an employee in the group. The requirements are indicated to the employee in the screen and the employee is asked to complete the design/order based on the requirements. If an employee in the group chooses a component, or an option that does not meet the requirements, the system warns the employee and does not allow the employee to check out his completed design. FIG. llE is an exemplary screen for notifying the employee that his design does not meet the requirement imposed by the administrator.

In block 108, the administrator can review employees' orders, make any changes if necessary and then, approve or reject the orders, as shown in block 110. This capability provides companies with the control over budget, uniformity of look, and combinations of components, while giving some flexibility to their employees to design and configure their own office furniture.

In one embodiment, the invention includes various functions to facilitate sales and order entry by furniture dealer sales representatives. For example, dealers may set up different accounts for a variety of sales representatives. Each sales representative may then establish accounts for his/her customers. The sales representatives would be able to review, manage, and get reports from only their own associated customers' accounts. However, the dealer is able to review and manage all customer's accounts and get an aggregated report on all or a selected number of customers.

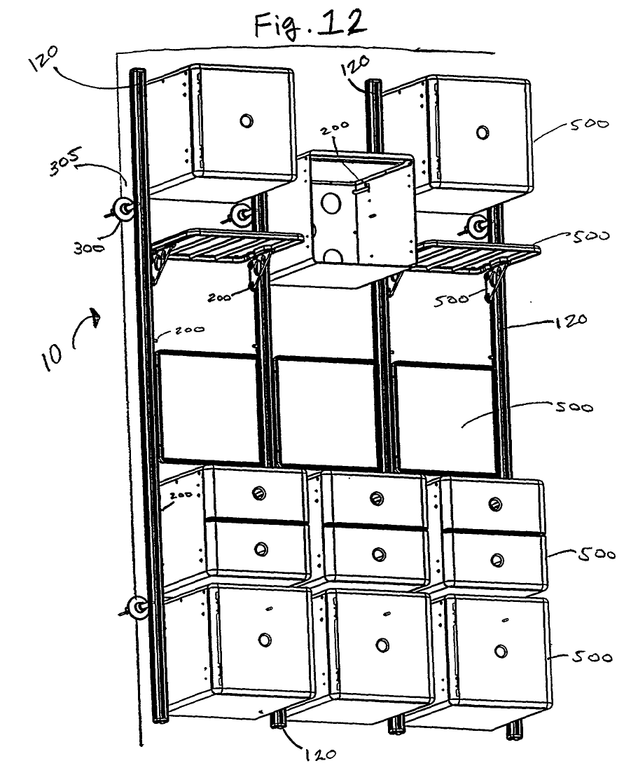

FIG. 12 is an exemplary arrangement of a furniture system 10 designed using the system and method of the present invention and utilizing the modular furniture components system. The furniture system 10 is shown as a surface mounted furniture system, but can also be configured as a mobile furniture system (not shown), or as an integral part of another piece of furniture, such as a cabinet. The furniture system 10 includes one or more grooved rails 140 (four are shown by way of example) that are adapted to receive clips 400 and brackets 200 which provide a means for connecting one or more fixtures 500 to the rails 140. For simplicity reasons, all fixtures are labeled with reference numeral “500,” however, there are many different fixtures that fall within the “fixtures 500” designation. For the surface mounted furniture system 10 shown in FIG. 12, a surface mount assembly 300 is used to secure the rails 140 to a support surface 305. In the embodiment shown in FIG. 12, the support surface 305 is a wall. For the mobile furniture system, a leg assembly is also used to support the rails 140 and fixtures 500.

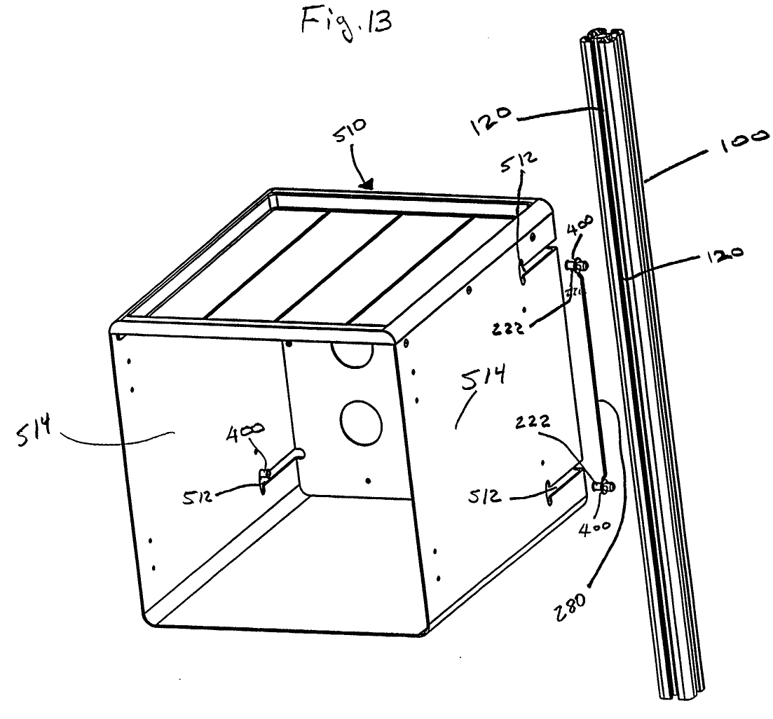

Referring to FIG. 13, the rails 140 contain at least one groove 120, depending on the surface upon which fixtures is secured to the rails. For the surface mounted furniture system 10 shown in FIG. 12, the rails preferably have at least two elongated grooves 120, wherein one of the grooves is used to accommodate the surface mount assembly 300 for securing the rail to the support surface 305, and the other groove 120 is used to accommodate one or more clips 400 for mounting one or more fixtures 500. The rails 140 generally have a greater length than width, wherein the grooves 120 extend along the length of the rails. The rails can be positioned, however, either vertically or horizontally, and can also have a number of different cross-sectional configurations, such as being generally square, circular, triangular, hexagonal, etc.

The rails 140 have for example, a generally square cross-sectional configuration and are positioned vertically so that the grooves extend vertically along the length of the rails. Moreover, the rails 140 have four identical sides, wherein each side comprises a groove, an exterior surface, an interior surface, a pair of internal lips, and a center extrusion. Constructing rails 140 with four identical sides allows any of the four sides to be used as a mounting surface and, thus, simplifies assembly of the furniture system.

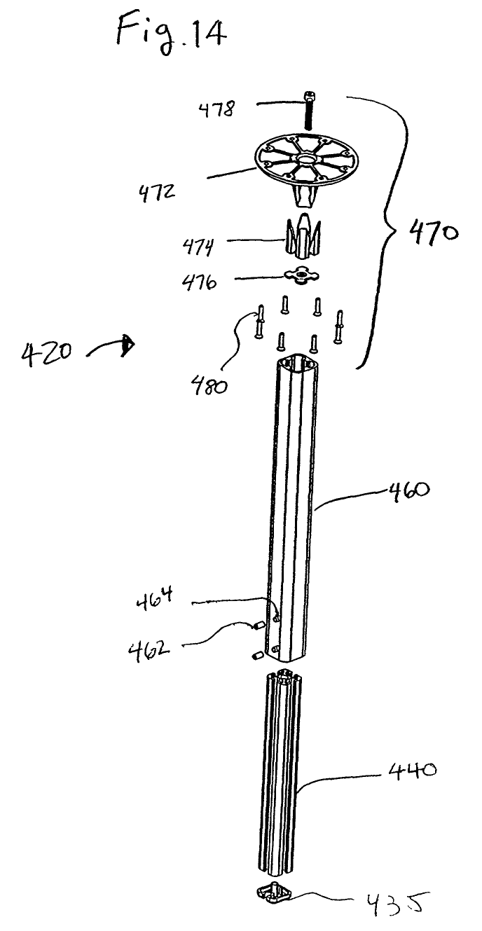

As shown in FIG. 14, the leg assembly 400 comprises at least one leg 420, wherein each leg 420 comprises a wedge-based locking mechanism 470, a tube 460, and a leg base 440. The wedge-based locking mechanism comprises a leg flange 472, a plurality of wedges 474, a nut plate 476, and a screw 478. The wedge-based locking mechanism is inserted as a single unit into the leg tube 460, and after the locking mechanism and leg tube are effectively locked together. This combined assembly is mounted to the bottom of the working surface 560 by securing a plurality of fasteners 480 through apertures in the leg flange 472.

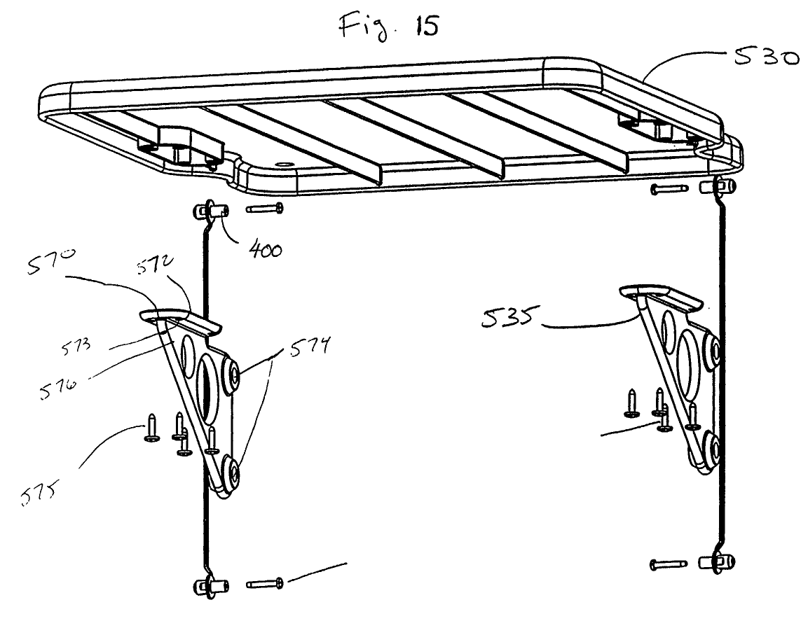

As shown in FIG. 15, each shelf 530 is mounted to a pair of gussets 570 and connected to the support surface 572 of each gusset by the screws 575. Thus, the shelves 530 are part of the category “fixtures 500” even though each shelf 530 first attaches to a separate fixture, namely the gusset 570, before attaching to grooved surfaces of the rails 140. Another structure for creating a shelf-like surface may have the gusset 570 served as the shelf by enlarging the support surface 572 to a size that can accommodate objects being placed on it. Therefore, the gusset 570 has a number of utilities, including attaching to different fixtures or serving as a stand alone fixture. A more detailed description of the modular furniture components system is included in the co-pending and commonly assigned U.S. Patent Application (Attorney Docket Number 45789/GSL/0205).

Appendix A is a non-exhaustive exemplary list of functions available to the user, according to one embodiment of the present invention.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for designing a configurable furniture product comprising the steps of:
accessing a plurality of 3-D modular furniture components images and data stored in a database via a computer network;
displaying a portion of the stored plurality of 3-D modular furniture components images and data selectable by a user;
placing one or more of the displayed modular furniture components images in a displayed screen responsive to a set of predetermined placement rules; and
arranging the placed modular furniture components to design the configurable furniture product.

2. The method of claim 1, wherein the computer network is Internet and the database is accessible via a web site.

3. The method of claim 1, further comprising the step of electronically transmitting a purchase order responsive to the designed furniture product.

4. The method of claim 3, further comprising the step of electronically transmitting fulfillment instructions responsive to the purchase order.

5. The method of claim 3, further comprising the step of electronically transmitting shipping instructions responsive to the purchase order.

6. The method of claim 1, further comprising the step of displaying a specification of the designed furniture product for review by the user.

7. The method of claim 6, wherein the displayed specification includes information about cost, quantity, size, and description of each component in the designed furniture product.

8. The method of claim 1, further comprising the step of editing the designed furniture product.

9. The method of claim 1, further comprising the step of assigning one or more options to the designed furniture product.

10. The method of claim 9, wherein the assigned options include color and texture.

11. The method of claim 1, further comprising the steps of:
displaying a catalog including a plurality of pre-arranged furniture products;
browsing through the displayed catalog;
selecting a pre-arranged furniture product; and
modifying the selected pre-arranged furniture product to design a customized furniture product.

12. The method of claim 1, further comprising the step of saving the designed configurable furniture product for a future use.

13. The method of claim 1, further comprising the step of saving the designed configurable furniture product in a customized catalog.

14. The method of claim 13, further comprising the step of electronically transmitting the saved furniture product over the computer network.

15. The method of claim 1, further comprising the steps of:
creating an employee group;
adding employee information to the created group;
assigning requirements to the created group; and
restricting each employee in the group to the assigned requirements for designing the configurable furniture product.

16. The method of claim 15, further comprising the step of electronically transmitting a message to each employee in the group.

17. The method of claim 15, further comprising the steps of reviewing the designed configuration of each employee in the group; and approving the reviewed configuration.

18. The method of claim 15, further comprising the step of notifying an employee if the employee's designed configuration violates any of the assigned requirements.

19. A method for designing a configurable furniture product utilizing a system of modular furniture components, the method comprising the steps of:
storing a plurality of 3-D modular furniture components images and data in a database accessible via a computer network;
storing a plurality of requirements input by an administrator;
displaying a portion of the plurality of 3-D modular furniture components images and data selectable by a user;
accepting inputs from the user for placing one or more of the displayed modular furniture components images and data in a displayed screen; and
configuring the placed modular furniture components images and data to design the configurable furniture product responsive to the stored requirements.

20. The method of claim 19, further comprising the step of preventing the placement of the modular furniture components if the placement is in violation of the stored requirements.

21. The method of claim 19, wherein the computer network is Internet and the database is accessible via a web site.

22. The method of claim 19, further comprising the step of electronically transmitting a purchase order responsive to the designed furniture product.

23. The method of claim 22, further comprising the step of electronically transmitting fulfillment instructions responsive to the purchase order.

24. The method of claim 22, further comprising the step of electronically transmitting shipping instructions responsive to the purchase order.

25. The method of claim 19, further comprising the step of displaying a specification of the designed furniture product for review by the user.

26. The method of claim 25, wherein the displayed specification includes information about cost, quantity, size, and description of each component in the designed furniture product.

27. The method of claim 19, further comprising the step of editing the designed furniture product.

28. The method of claim 19, further comprising the step of assigning one or more options to the designed furniture product.

29. The method of claim 19, further comprising the steps of:
displaying a catalog including a plurality of pre-arranged furniture products;
browsing through the displayed catalog;
selecting a pre-arranged furniture product; and
modifying the selected pre-arranged furniture product to design a customized furniture product.

30. The method of claim 19, further comprising the step of saving the designed configurable furniture product in a customized catalog.

31. The method of claim 19, further comprising the step of notifying the user if the designed configuration violates any of the stored requirements.

32. A system for designing a configurable furniture product comprising:
a database accessible via a computer network for storing a plurality of 3-D modular furniture components images and data;
a display screen for displaying a portion of the plurality of 3-D modular furniture components images and data selectable by a user;
a placement module for placing one or more of the displayed modular furniture components images in a displayed screen responsive to a set of predetermined placement rules; and
means for arranging the placed modular furniture components to design the configurable furniture product.

33. The system of claim 32, wherein the computer network is Internet and the database is accessible via a web site.

34. The system of claim 32, further comprising means for electronically transmitting a purchase order responsive to the designed furniture product.

35. The system of claim 34, further comprising means for electronically transmitting fulfillment instructions responsive to the purchase order.

36. The system of claim 34, further comprising means for electronically transmitting shipping instructions responsive to the purchase order.

37. The system of claim 32, further comprising means for displaying a specification of the designed furniture product for review by the user.

38. The system of claim 37, wherein the displayed specification includes information about cost, quantity, size, and description of each component in the designed furniture product.

39. The system of claim 32, further comprising means for editing the designed furniture product.

40. The system of claim 32, further comprising means for assigning one or more options to the designed furniture product.

41. The system of claim 32, further comprising:
means for displaying a catalog including a plurality of pre-arranged furniture products;
means for browsing through the displayed catalog;
means for selecting a pre-arranged furniture product; and
means for modifying the selected pre-arranged furniture product to design a customized furniture product.

42. The system of claim 32, further comprising a memory for saving the designed configurable furniture product.

43. The system of claim 42, further comprising means for electronically transmitting the saved furniture product over the computer network.

44. The system of claim 32, further comprising:
means for creating an employee group;
means for adding employee information to the created group; and
means for assigning requirements to the created group; and
means for restricting each employee in the group to the assigned requirements for designing the configurable furniture product.

45. The system of claim 44, further comprising means for electronically transmitting a message to each employee in the group.

46. The system of claim 44, further comprising means for reviewing the designed configuration of each employee in the group; and means for approving the reviewed configuration.

47. The system of claim 44, further comprising means for notifying an employee if the employee's designed configuration violates any of the assigned requirements.

48. A system of configurable unified modular furniture components comprising:
a plurality of modular furniture components;
a database including electronic images and specifications of the plurality of modular furniture components;
a website accessible by a furniture end-user;
a configurator accessible via the web site by the furniture end-user for configuring a furniture product including a selected portion of the plurality of modular furniture components utilizing the images and specifications stored in the database, wherein the configured furniture product is assembled using the selected portion of the plurality of modular furniture components and information generated by the configurator.

49. The system of claim 48, wherein the plurality of modular furniture components includes one or more of a rail, a clip, a fastener, and a fixture.

50. The system of claim 48, wherein the plurality of modular furniture components includes a plurality of rails, means for securing a fixture to the rails, and a connector for adjoining two rails.

51. The system of claim 49, wherein the fixture is one or more of a hanging rod, a board, a gusset, and a shelf.

52. The system of claim 48, wherein the configurator includes:
a display screen for displaying a selectable portion of the electronic images and specifications from the database;
a placement module for placing one or more of the displayed modular furniture components images in a displayed screen responsive to a set of predetermined placement rules; and
means for arranging the placed modular furniture components to configure the furniture product.

53. The system of claim 48, wherein the configurator includes means for electronically transmitting a purchase order responsive to the configured furniture product.

54. The system of claim 53, wherein the configurator includes means for electronically transmitting fulfillment instructions responsive to the purchase order.

55. The system of claim 53, wherein the configurator includes means for electronically transmitting shipping instructions responsive to the purchase order.

56. The system of claim 48, wherein the configurator includes means for displaying a specification of the designed furniture product for review by the user.

57. The system of claim 56, wherein the displayed specification includes information about cost, quantity, size, and description of each component in the designed furniture product.

58. The system of claim 48, wherein the configurator includes means for editing the designed furniture product.
